(19) United States
(12) Patent Application Publication
(10) Pub. No.: US 2009/0115796 A1
(43) Pub. Date: May 7, 2009

(54) PRIORI INFORMATION ENCODING FOR MANUAL ADAPTATION OF GEOMETRIC MODELS

(75) Inventors: Juergen Weese, Aachen (DE); Olivier Ecabert, Aachen (DE); Jochen Peters, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,840

(22) PCT Filed: Sep. 20, 2006
(86) PCT No.: PCT/IB2006/053394

§ 371 Date: Sep. 9, 2008

(30) Foreign Application Priority Data
Sep. 23, 2005 (EP) 05108818.5

(51) Int. Cl. G09G 5/00

(52) U.S. Cl. 345/619

(57) ABSTRACT

The invention relates to the adaptation method (200) of adapting a geometric model to an image data comprising a region selection step (230) for selecting a region of the geometric model and a manual adaptation step (235) for manually adapting the geometric model to the image data using a set of characteristics of the region comprised in the geometric model. Using a region-specific characteristic from the set of characteristics of the selected region, such as a region-specific parameter determining the deformation range, for manually adapting the geometric model to the image data, requires relatively fewer user interactions.

This invention relates to an adaptation method of adapting a geometric model to an image data.

The invention further relates to an adaptation system for adapting a geometric model to an image data.

The invention further relates to an acquisition system for acquiring an image data comprising said adaptation system.

The invention further relates to a workstation comprising said adaptation system.

The invention further relates to a computer program product to be loaded by a computer arrangement, comprising instructions for adapting a geometric model to an image data.

An embodiment of the adaptation method of the kind described in the opening paragraph is described in WO2005/038711, hereinafter referred to as Ref. 1. The document describes a few manual tools, such as a Gaussian pull tool and a Sphere push tool, for modifying a geometric model in order to improve the result of automatic adaptation of the geometric model to an image data. For example, in an embodiment of the adaptation method the user can select a vertex of a mesh representing the geometric model and pull it to a desired location using a Gaussian pull tool. The surrounding vertices may be also displaced. Their displacements are controlled by a smooth function such as a Gaussian function centered at the selected vertex.

The drawback of that method is that the deformation of the geometric model is controlled by a geometric parameter of the tool. For example, a parameter such as a radius of the Gaussian function modeling the deformation defined, for example, as a square root of the variance of the Gaussian function, is used to control the deformation induced by the Gaussian pull tool. Pulling a vertex of the geometric model towards a boundary in the image data may lead to a deformation of the geometric model, which does not align the boundary of the geometric model with a target boundary in the image data. Eventually, all errors in the alignment of the boundaries of the geometric model may be corrected by manipulating multiple vertices until the manual adaptation is completed. Alternatively, a parameter of the tool can be interactively set by a user to optimize the tool. However, either solution may require a lot of user interactions and thus may be very time consuming.

It is an object of the invention to provide an adaptation method of the kind described in the opening paragraph that requires relatively fewer user interactions.

This object of the invention is achieved in that the adaptation method of adapting a geometric model to an image data comprises
a region selection step for selecting a region of the geometric model; and
a manual adaptation step for manually adapting the geometric model to the image data using a set of characteristics of the region comprised in the geometric model.

A standard selection tool operated using a mouse is used for selecting a region of the geometric model to be manually adapted to the image data. The same tool is used for manually adapting the geometric model to align it with a perceived object comprised in the image data. According to the current invention, the deformations of the geometric model are controlled by a set of characteristics of the selected region. The set of characteristic is comprised in the geometric model. This allows applying an optimized tool parameter to the selected region of the geometric model. For example, in case of a geometric model represented by an adaptive mesh comprising a plurality of vertices, each vertex of the mesh is a region of the geometric model. Each vertex may be characterized by its own weight function for controlling the deformation of the mesh induced by a pull tool applied to that region. The weight function comprises weights of all vertices of the mesh, most of them being usually zero. When the pull tool is applied to a selected vertex the displacement of each vertex in the mesh is proportional to the weight of the selected vertex. The weight of the selected vertex is one. For example, the value of a weight function at a certain vertex may decrease exponentially. The exponent may be proportional to the distance from the certain vertex to the selected vertex. Such a weight function is characterized by a rate of decay with the distance to the selected region. The rate of decay of a weight function associated with a selected vertex determines the range of the deformation induced by applying the pull tool to that vertex. If the vertices in an area around the selected vertex are strongly coupled with each other, such as vertices representing a flat area of a bone, for example, the decay rate of the pull tool is relatively small. Pulling a vertex from this area with the pull tool will result in similar displacement of neighboring vertices. On the other hand, if the vertices in an area around the selected vertex are weakly coupled with each other, such as vertices representing a curved soft tissue, the rate of decay of the weight function should be relatively large. Pulling a vertex from this area with the pull tool will have relatively limited effect on the displacement of neighboring vertices. Only vertices close to the pulled vertex will be significantly displaced. The vertex displacements will be rapidly decreasing with the distance to the selected vertex. Thus, by using a characteristic of the selected region, such as the decay rate, for adapting the geometric model to the image data, the adaptation method of the current invention requires relatively fewer user interactions.

In an embodiment of the adaptation method according to the invention, the geometric model comprises a tool for manually adapting the geometric model and the method further comprises a tool selection step for selecting the tool. The method of the current invention uses a tool, such as a pull tool and a push tool of Ref. 1, for manually adapting the region to the image data. The tool may be comprised in the set of characteristics of the region. Each region may store its own tool that is most useful for adapting said region. Alternatively, the tool may be a global tool. The set of characteristics may comprise a parameter for controlling the way of working of the tool that is most useful for adapting said region.

In a further embodiment of the adaptation method according to the invention, the geometric model comprises a configuration of the tool for manually adapting the geometric model and the adaptation method further comprises a configuration selection step for selecting the configuration. The configuration of the tool may be comprised in the set of characteristics of the region. Each region may store its own configuration of the tool that is most useful for adapting said region. Optionally, the geometric model can comprise a plurality of configurations. An example of a configuration of a pull tool is the orientation of a tool for vessel adaptation relative to a vessel. In a first predefined orientation relative to the vessel centerline, the tool acts as a pull tool applied to a vessel boundary. At a second orientation relative to the vessel centerline, the tool acts as a pull tool applied to the vessel centerline.

In a further embodiment of the adaptation method according to the invention, the adaptation method further comprises an automatic adaptation step for automatically adapting the geometric model to the image data wherein the manual adaptation step further comprises a boundary condition step for manually setting a boundary condition for the automatic adaptation step. Some geometric models for automatic adaptation such as triangular meshes described in an article “Shape constrained deformable models for 3D medical image segmentation” by J. Weese, V. Pekar, M. Kaus, C. Lorenz, S. Lobregt, and R. Truyen, published in Proc. IPMI, 380-387, Springer Verlag, 2001, hereinafter referred to as Ref. 2, already comprise a set of characteristics, an a priori information, for adapting the geometric model. In this case, the user may select certain parts of the geometric model and pulls these parts to the desired location in the manual adaptation step. The selected parts, as well as the part of the geometric model outside a volume of a predetermined shape and size enclosing the selected parts are fixed to their new locations defining a boundary condition. The geometric model is then adapted in the automatic adaptation step. The adapted geometric model satisfies the imposed boundary condition. Only these parts of the geometric model, which are not fixed by the boundary condition, are adapted. An advantage of this embodiment is that no additional set of characteristic of the region for manually adapting the geometric model is necessary. The set of characteristics of the region already available in these geometric models is used in the automatic adaptation step. Optionally, the geometric model may comprise a set of characteristics of the region for manually setting the boundary condition.

In a further embodiment of the adaptation method according to the invention, the adaptation method further comprises a segmenting step for segmenting the image data. Applying the adaptation method to multiple objects comprised in an image data allows a medical practitioner to delineate said multiple objects. This contributes to a better visualization of the image data and enables the medical practitioner to extract quantitative data such as geometric parameters of objects comprised in the image data.

It is a further object of the invention to provide an adaptation system of the kind described in the opening paragraph that requires relatively fewer user interactions. This is achieved in that the adaptation system for adapting a geometric model to an image data comprises:
a region selection unit for selecting a region of the geometric model; and
a manual adaptation unit for manually adapting the region to the image data on the basis of a set of characteristics of the region comprised in the geometric model.

It is a further object of the invention to provide an image acquisition system of the kind described in the opening paragraph that requires relatively fewer user interactions. This is achieved in that the image acquisition system comprises an adaptation system for adapting a geometric model to an image data, the adaptation system comprising:
a region selection unit for selecting a region of the geometric model; and
a manual adaptation unit for manually adapting the region to the image data on the basis of a set of characteristic of the region comprised in the geometric model.

It is a further object of the invention to provide a workstation of the kind described in the opening paragraph that requires relatively fewer user interactions. This is achieved in that the workstation comprises an adaptation system for adapting a geometric model to an image data, the adaptation system comprising:
a region selection unit for selecting a region of the geometric model; and
a manual adaptation unit for manually adapting the region to the image data on the basis of a set of characteristic of the region comprised in the geometric model.

It is a further object of the invention to provide a computer program product of the kind described in the opening paragraph that requires relatively fewer user interactions. This is achieved in that the computer program product to be loaded by a computer arrangement, comprising instructions for adapting a geometric model to an image data, the computer arrangement comprising a processing unit and memory, the computer program product, after being loaded, provides said processing unit with the capability to carry out the following tasks:
selecting a region of the geometric model; and
manually adapting the region to the image data on the basis of a set of characteristic of the region comprised in the geometric model.

Modifications and variations thereof, of the adaptation system, of the image acquisition system, of the workstation, and/or of the computer program product, which correspond to modifications of the adaptation method and variations thereof, being described, can be carried out by a skilled person on the basis of the present description.

The adaptation method of the present invention is useful for adapting geometric models to 2D, to 3D, and/or to 4D image data. Although the embodiments primarily describe adapting geometric models to 3D image data, the extension of the adaptation method, of the adaptation system, of the image acquisition system, of the workstation, and/or of the computer program product to other dimensions of the image data being obvious to the skilled person can be carried out on the basis of the description of the current invention. The image data can be routinely generated nowadays by various data acquisition modalities such as Magnetic Resonance Imaging (MRI)), Computed Tomography (CT), Ultrasound (US), Positron Emission Tomography (PET), and Single Photon Emission Computed Tomography (SPECT).

These and other aspects of the adaptation method, of the adaptation system, of the image acquisition system, of the workstation, and of the computer program product according to the invention will become apparent from and will be elucidated with respect to the implementations and embodiments described hereinafter and with reference to the accompanying drawings, wherein:

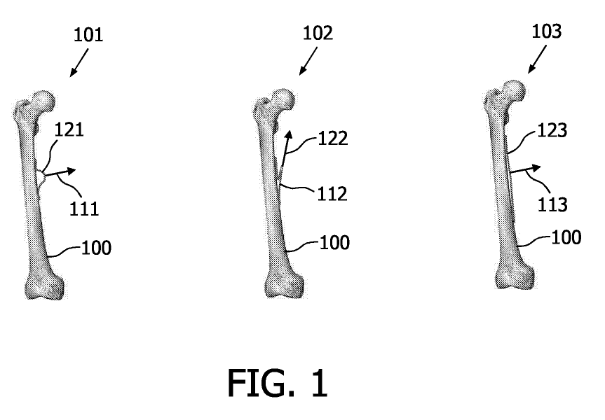

FIG. 1 schematically shows results of manual adaptation of a femur;

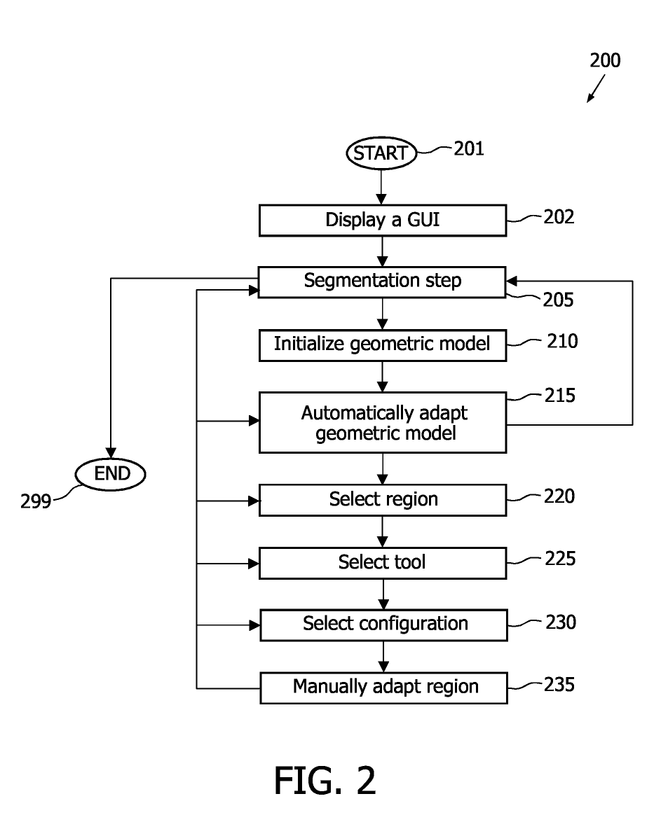

FIG. 2 shows a simplified flowchart of an exemplary embodiment of the adaptation method;

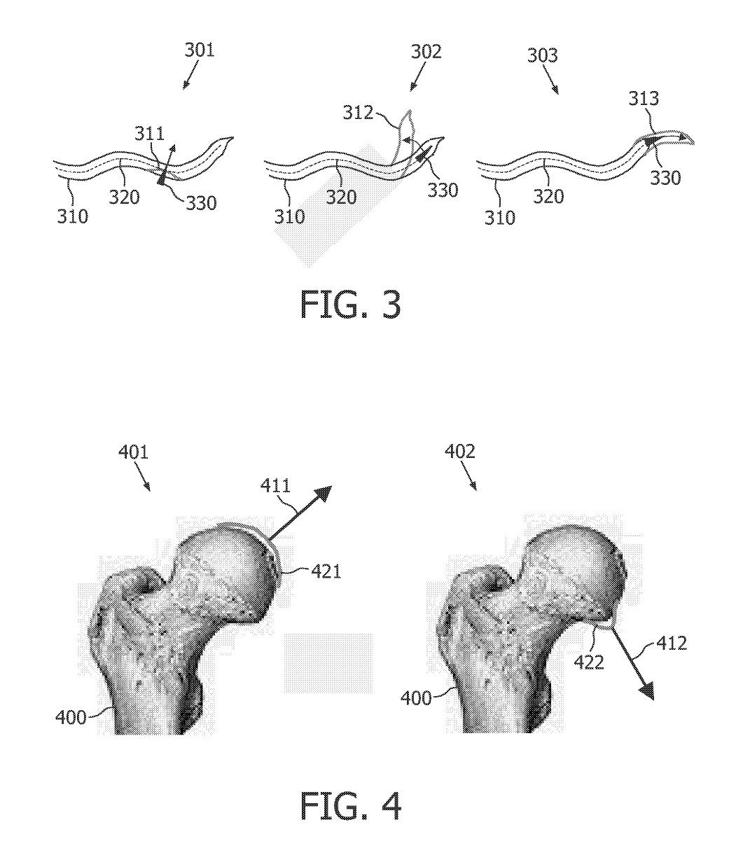

FIG. 3 schematically shows results of manual adaptation of a vessel;

FIG. 4 schematically shows results of manual adaptation of a femur head;

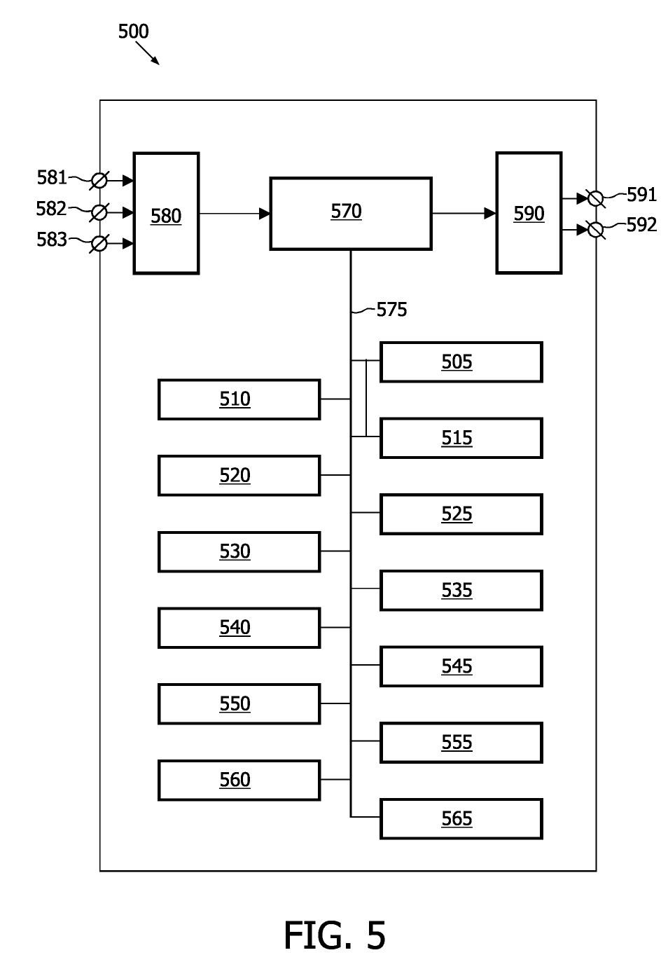

FIG. 5 shows a block diagram of an embodiment of the adaptation system;

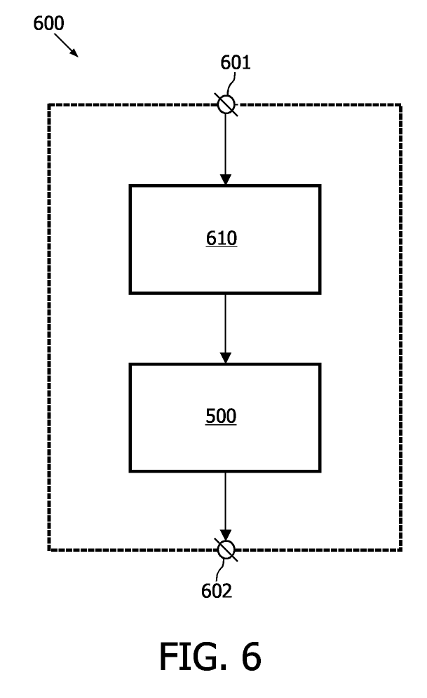

FIG. 6 schematically shows an embodiment of the image acquisition system; and

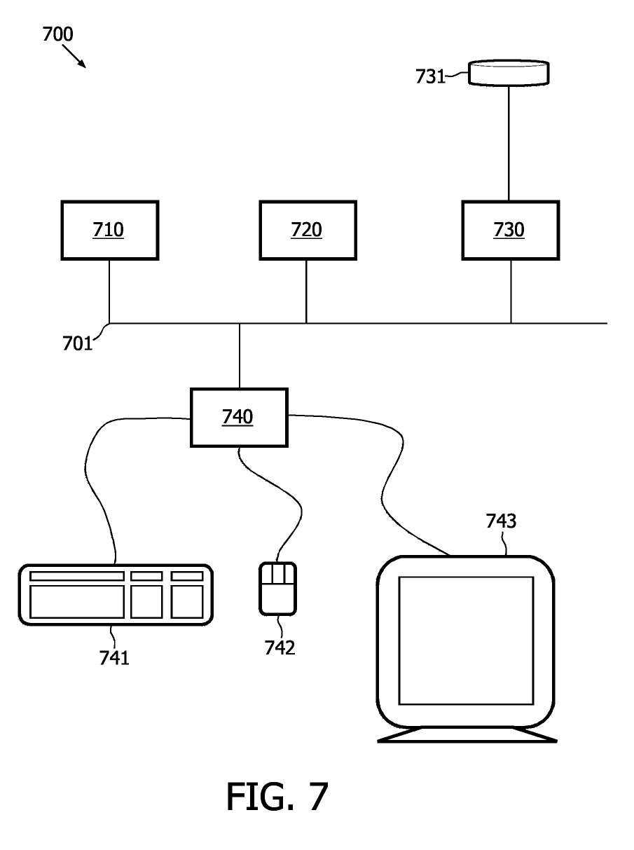

FIG. 7 schematically shows an embodiment of the workstation.

Same reference numerals are used to denote similar parts throughout the figures.

FIG. 1 schematically shows effects manual adaptation on the femur 100. A pull tool such as the Gaussian pull tool described in Ref. 1 is applied to the femur 100. In the first illustration 101 the Gaussian pull tool is applied to the region indicated by the beginning of the first arrow 111 and pulled in the direction indicated by the first arrow 111. The resulting deformation is outlined by the first contour 121. In the second illustration 102 the Gaussian pull tool is applied to the region indicated by the beginning of the second arrow 112 and pulled in the direction indicated by the second arrow 112. The resulting deformation is outlined by the second contour 122. The deformations outlined by the first contour 121 and the second contour 122 are invalid. Such deformations should not be allowed. It is rather impossible to have a femur 100 deformed in the way shown in these two illustrations. This is because the Gaussian pull tools shown in the first illustration 101 and in the second illustration 102 use purely geometrical and very local information.

In the third illustration 103 in FIG. 1, the Gaussian pull tool is applied to the region indicated by the beginning of the third arrow 113 and pulled in the direction indicated by the third arrow 113. The resulting deformation is outlined by the third contour 123. Here the deformation marked by the third contour 123 extends over a long stretch of the femur 100. The Gaussian pull tool of Ref. 1 has one new feature: it uses a priori and more global information about the region of the femur 100, to which said Gaussian pull tool is applied. This new feature illustrates the advantage of using the method of the current invention over the method of the prior art.

FIG. 2 shows a simplified flowchart of an exemplary embodiment of the adaptation method 200 of adapting a geometric model to an image data, the adaptation method 200 comprising:
an initializing step 210 for initializing the geometric model;
a region selection step 220 for selecting a region of the geometric model; and
a manual adaptation step 235 for manually adapting the region to the image data using a set of characteristics of the region comprised in the geometric model.

Optionally, the adaptation method 200 further comprises:
a segmentation step 205 for segmenting the image data;
an automatic adaptation step 215 for automatically adapting the geometric model to the image data;
a tool selection step 225 for selecting a tool for manually adapting the region to the image data; and
a configuration selection step 230 for setting a configuration of the tool for manually adapting the region to the image data.

With further reference to FIG. 2 after the start step 201 the method 200 continues to the GUI step 202 for displaying a graphical user interface for communicating information to the user. The method 200 then continues to the segmentation step 205. If the there are no further objects in the image data to which a geometric model has to be adapted, the adaptation method 200 continues to the end step 299, where the process governed by the adaptation method 200 ends. Otherwise a geometric model to be adapted to the image data is selected. Next the selected geometric model is initialized in the initializing step 210. For example, the geometric model may be placed in the image near an object in the image data to which the geometric model is being adapted. Optionally, the geometric model may be further rotated, translated, and/or scaled to match the object to which the geometric model is being adapted. After the initializing step 210 the automatic adaptation step 215 for automatically adapting the initialized geometric model to the image data is carried out. If there is no need for manually adapting the geometric model the adaptation method 200 continues to the segmentation step 205. If there is a region of the geometric model that still needs to be adapted to the image data, the region is selected in the region selection step 220. Next a tool from a set of tools is selected in tool selection step 225. Next a configuration of the tool relative to the image data is set in step 230. Once the region is selected and the tool for manually adapting the region to the image data is ready, the geometric model is manually adapted to the image data in the manual adaptation step 235.

After the manual adaptation step 235 the method 200 may continue to the automatic adaptation step 215 to automatically adapt the geometric model to the image data on the basis of new boundary conditions defined in the manual adaptation step, to the region selection step 220 to select another region for manual adaptation, to the tool selection step 225 to select a tool for manually adapting the geometric model to the image data, or to the configuration selection step 230 to select a configuration of the tool for manually adapting the geometric model to the image data. If there is no need for adapting the geometric model, the method 200 continues to the segmentation step 205.

In an embodiment of the adaptation method 200 according to the invention, the geometric model is based on a mesh comprising a plurality of vertices. In a further embodiment of the adaptation method 200 according to the invention, the mesh is a polygonal mesh such as a triangular mesh used in Ref. 2. A polygonal mesh represents a surface of the modeled objects. A polygonal mesh is relatively easy to implement. Adaptation of a polygonal mesh rarely requires excessive computing time. Alternatively geometric models can be based on tetrahedral meshes. The skilled person will understand that there are many geometric models that can be adapted using the adaptation method 200 of the current invention. The meshes used in the description of the embodiments of the current invention are for illustration purpose only and do not limit the scope of the claims.

In a further embodiment of the adaptation method 200 according to the invention, the adaptation method 200 optionally comprises a segmenting step 205. The segmenting step 205 allows using the adaptation method 200 for adapting multiple geometric models to the image dataset for delineating objects of interest comprised in the image data. The segmenting step 205 is also used as a control step for controlling the loop comprising a cycle for adapting one geometric model to the image data. Alternatively, the adaptation method 200 may be for adapting a predetermined geometric model to an object in the image data to calculate object characteristics. In this case no segmenting step 205 is required. For example, the adaptation method 200 can be used to compute volume and other characteristics of a heart object comprised in the image.

In the initializing step 210 the geometric model is initialized. For example, the geometric model may be placed in the image near an object in the image data to which the geometric model is being adapted. Optionally, the geometric model may be further rotated, translated, and/or scaled to match the object to which the geometric model is being adapted. The initializing step can be done manually or can be automated.

In a further embodiment of the adaptation method 200 according to the invention, the geometric model may be automatically adapted to the image data in the automatic adaptation step 215. For example, for a triangular mesh representing the geometric model one can use the adaptation method 200 described in Ref. 2. The skilled person will appreciate the fact that there are many automatic adaptation methods known in the art and that any combination of them can be used in the automatic adaptation step 215.

The region selection step 220 is a very important step as the selected region defines a set of characteristics of the selected region, which is used in the manual adaptation step to align said region of the geometric model with the image data in the manual adaptation step 230. Optionally, the selected region can be used to define a set of tools for manually adapting the geometric model to the image data from which one tool may be selected in the tool selection step 225 as described in a further embodiment of the current invention. A further option is to use the region selected in the region selection step 220 and the tool selected in the tool selection step for determining a set of tool configurations as well as the allowed values of parameters for each tool configuration from the set of tool configurations in the configuration selection step 230 as described in a further embodiment of the current invention.

In a further embodiment of the adaptation method 200 according to the invention, the region selection step 220 for selecting a region in the image data is arranged to use a GUI tool for rotating and translating the displayed view, such as a projection view or a cross section view, comprising the geometric model overlaid with a view rendered from the image data in order to render a useful view for selecting the region to be manually adapted to the image data. The rotations and translations are preferably defined for 3D image data.

In a further embodiment of the adaptation method 200 according to the invention, the geometric model comprises a tool for manually adapting the geometric model and the adaptation method 200 further comprises a tool selection step 225 for selecting the tool. The adaptation method 200 of the current invention uses a tool, such as a pull tool and a push tool, for manually adapting the region to the image data. The tool may be comprised in the set of characteristics of the region. Each region may store its own tool that is most useful for adapting said region. Alternatively, the tool may be a global tool. The set of characteristics may comprise a parameter for controlling the way of working of the tool that is most useful for adapting said region. Optionally, the geometric model can comprise a set of tools for manually adapting the geometric model.

In case of the geometric model based on a polygonal mesh, each polygon may be assigned a set of tools useful for manually adapting a region of the geometric model, said region comprising the polygon. For example, each polygon may be assigned a pull tool and a push tool. Each tool may be controlled by a parameter comprised in the set of characteristics of the polygon. For example, a pull tool can be controlled by a function, such as a Gaussian function, determining relative displacements of the polygons of the mesh relative to the pulled polygon. Optionally, the pull tool can be controlled by a plurality of parameters. This is especially useful for adapting geometric models to a 3D image data. For example, a radius of a Gaussian pull tool may be replaced by two radii as described in Ref. 1. In the tool selection step 225, the tools assigned to a polygon may be displayed by the GUI when the mouse pointer is placed over the polygon.

In a further embodiment of the adaptation method 200 according to the invention, the geometric model comprises a configuration of the tool for manually adapting the geometric model and the adaptation method 200 further comprises a configuration selection step 230 for selecting the configuration. The configuration of the tool may be comprised in the set of characteristics of the region. Each region may store its own configuration of the tool that is most useful for adapting said region. Optionally, the geometric model can comprise a plurality of configurations. The user can manipulate the configuration of the tool using a user input device such as a mouse.

An example of a predefined configuration is the orientation of a pull tool for vessel adaptation relative to a vessel. FIG. 3 schematically shows an effect of manual adaptation of a geometric model 310 representing a vessel. The tool 330 for adapting the vessel boundary 310, represented by an isosceles triangle 330, may be oriented parallelly or perpendicularly to the centerline 320 of the vessel. Each orientation of the tool 330 may be classified either as a parallel or as a perpendicular configuration on the basis of the angle between the tool and the centerline 320 of the vessel. In the first illustration 301 the tool is substantially perpendicular to the centerline. In this configuration the tool is applied to the vessel boundary 310 to deform the vessel boundary 310. Such adaptation results in a deformation of the vessel boundary 310 as outlined by a first contour 311. In the second illustration 302 and in the third illustration 303 the tool 330 is substantially parallel to the centerline 320 of the vessel. In this configuration the tool 330 is applied to the vessel centerline 320 to bend or to stretch the vessel boundary 320. A result of bending the vessel boundary 310 is outlined in illustration 302 by a second contour 312. A result of stretching the boundary 310 is outlined in illustration 303 by a third contour 313.

Alternatively, a similar effect may be defined on the basis of the region of the geometric model determined by the point of application of the tool 330 into account. If the tool is applied at or near the vessel boundary, the tool acts on the vessel boundary. If the tool is applied at or near the vessel centerline, the tool acts on the vessel centerline.

Alternatively, there may be two different tools, a first tool for adapting the vessel boundary and a second tool for adapting the vessel centerline. Tools may be assigned to regions of the geometric model. If the mouse pointer is placed at or near the vessel boundary, the first tool is active. If the mouse pointer is placed at or near the vessel centerline, the second tool is active.

In the manual adaptation step 235 the selected region of a geometric model is manually adapted to the image data on the basis of a region characteristic comprised in the geometric model. The region characteristic comprises information on the allowed deformations of the region of the geometric model. The deformation may depend on many conditions such as the stiffness of the modeled tissue and the curvature of the surface of the geometric model in the region. Thus, a parameter controlling the tool depends on the region. This is illustrated in FIG. 4, which schematically shows results of manual adaptation of a femur head 400. The tool is a Gaussian pull too, for example. The parameter controlling the tool is the radius of the Gaussian function modeling the deformation of the femur head defined, for example, as a square root of the variance of the Gaussian function. The radius depends on the region of application of the Gaussian pull tool.

In the first illustration 401 of FIG. 4 the Gaussian pull tool is applied to the pole of the hemisphere of the femur head 400 as shown by the arrow 411. The resulting deformation is indicated by the first contour 421. In the second illustration 402 of FIG. 4 the Gaussian pull tool is applied to the base of the hemisphere of the femur head 400 as shown by the arrow 412. The resulting deformation is indicated by the second contour 422. The radius of the first contour 421 is larger than the radius of the second contour 422. A reason for that difference is the fact that the curvature at the pole of the hemisphere of the femur head 400 is smaller than the curvature at the base of the hemisphere of the femur head 400.

The skilled person will understand that the displacements of parts can be implemented in several ways. For example, in case of a pull tool applied to a geometric model represented by a mesh of vertices, the displacement vector of a certain vertex can be defined by the displacement vector of the pulled vertex and a weight assigned to the certain vertex. Optionally, the direction of the displacement vector of the certain vertex can be different from the direction of the displacement of the pulled vertex. Alternatively, the displacement vector of the certain vector can be calculated using a vector-valued function of local coordinates of the certain vertex in a local coordinate system with the origin at the pulled vertex. Alternatively, an internal energy expression with a boundary condition based on the displacement of the pulled vertex may be optimized to compute the displacements of the certain vertex, as described in a further embodiment of the present invention. The skilled person will appreciate the fact that here are other methods for computing the displacement of the certain vertex on the basis of a deformation of the mesh induced be a tool. Some of them may be associated with a pull tool; other can be associated with other tools.

In a further embodiment of the adaptation method 200 according to the invention, the manual adaptation step 235 further comprises a boundary condition step for manually setting a boundary condition for the automatic adaptation step 215. A region of the geometric model is adapted in the manual adaptation step 235. During a manual adaptation, the user selects certain parts of the geometric model, for example vertices of a mesh representing the geometric model, and pulls these parts to the desired location. The selected parts, as well as the part of the geometric model outside a volume of a predetermined shape and size encompassing the selected parts, are fixed to their new locations defining a boundary condition. The geometric model is then adapted in the automatic adaptation step 215. The adapted geometric model satisfies the imposed boundary condition. Only these parts of the geometric model, which are not fixed by the boundary condition, are adapted. An advantage of this embodiment is that no extra characteristic of the region for manually adapting the geometric model is necessary. The whole adaptation is carried out on the basis of a characteristic comprised in the geometric model and used by automatic adaptation step 215.

In a further embodiment of the adaptation method 200 according to the invention, the geometric model based on triangular mesh and the adaptation method based on the minimization of the combined internal and external geometric model potential energy is used. This model and method are described in Ref. 2. In this embodiment the image driven boundary points usually used for the external energy are replaced with the manually selected points. The boundary conditions can be implemented by assigning very large weights to the external energy terms describing attraction of the adapted parts to their manually selected locations, much larger than weights assigned to any other term in the geometric model potential energy. The displacements of triangles of the mesh are determined by the internal energy parameters and the boundary condition. The skilled person will understand that finding the minimum of the geometric model potential energy may be generalized and carried out by finding a stationary solution to an equation of motion in a force field. In particular, the equation of motion may be solved using simulation, which employs terms responsible for energy dissipation thus promoting fast convergence of the simulation.

Alternatively, a method based on optimization of another cost function as known in the art can be used. The locations of manually displaced triangles or vertices of the mesh define a boundary condition and are not optimized.

The adaptation method 200 may be advantageously used for correcting the results of automatic adaptation. Alternatively, the adaptation method 200 may be used as a method of choice for adapting a geometric model to an image data.

The order in the described embodiments of the method 200 of the current invention is not mandatory, the skilled person may change the order of steps or perform steps concurrently using threading models, multi-processor systems or multiple processes without departing from the concept as intended by the present invention. Optionally, two steps of the method 200 of the current invention can be combined into one step. Optionally, a step of the adaptation method 200 of the current invention can be split into a plurality of steps.

FIG. 5 schematically shows an embodiment of the adaptation system 500 for adapting a geometric model to an image data, the adaptation system 500 comprising:
an initializing unit 510 for initializing the geometric model;
a region selection unit 520 for selecting a region of the geometric model; and
a manual adaptation unit 535 for manually adapting the region to the image data on the basis of a region characteristic of the region comprised in the geometric model.

Optionally, the adaptation system 500 further comprises:
a segmentation unit 505 for segmenting the image data;
an automatic adaptation unit 515 for automatically adapting the geometric model to the image data;
a tool selection unit 525 for selecting a tool for manually adapting the region to the image data;
a configuration selection unit 530 for setting a configuration of the tool, e.g., relative to the image data; and
a user interface 565 for communicating with the detection system 500.

In the embodiment of the adaptation system 500 shown in FIG. 5, there are three input connectors 581, 582 and 583 for the incoming data. The first input connector 581 is arranged to receive data incoming from data storage such as a hard disk, a magnetic tape, flash memory, or an optical disk. The second input connector 582 is arranged to receive data incoming from a user input device such as a mouse or a touch screen. The third input connector 583 is arranged to receive data incoming from a user input device such as a keyboard. The input connectors 581, 582 and 583 are connected to an input control unit 580.

In the embodiment of the adaptation system 500 shown in FIG. 5, there are two output connectors 591 and 592 for the outgoing data. The first output connector 591 is arranged to output the data to data storage such as a hard disk, a magnetic tape, flash memory, or an optical disk. The second output connector 592 is arranged to output the data to a display device. The output connectors 591 and 592 receive the respective data via an output control unit 590.

The skilled person will understand that there are many ways to connect input devices to the input connectors 581, 582 and 583 and the output devices to the output connectors 591 and 592 of the adaptation system 500. These ways comprise, but are not limited to, a wired and a wireless connection, a digital network such as a Local Area Network (LAN) and a Wide Area Network (WAN), the Internet, a digital telephone network, and an analogue telephone network.

In an embodiment of the adaptation system 500 according to the invention, the adaptation system 500 comprises a memory unit 570. The memory unit 570 is arranged to receive an input data from external devices via any of the input connectors 581, 582, and 583 and to store the received input data in the memory unit 570. Loading the data into the memory unit 570 allows a quick access to relevant data portions by the units of the adaptation system 500. The input may data comprise, but is not limited to, the image data. The memory unit 570 can be implemented by devices such as a Random Access Memory (RAM) chip, a Read Only Memory (ROM) chip, and/or a hard disk. Preferably, the memory unit 570 comprises a RAM for storing the image dataset. The memory unit 570 is also arranged to receive data from and to deliver data to the units of the adaptation system 500 comprising the segmentation unit 505, the initializing unit 510, the automatic adaptation unit 515, the region selection unit 520, the tool selection unit 525, the configuration selection unit 530, the manual adaptation unit 535, the user interface 565, via the memory bus 575. The memory unit 570 is further arranged to make the data available to external devices via any of the output connectors 591 and 592. Storing the data from the units of the adaptation system 500 in the memory unit 570 advantageously improves the performance of the units of the adaptation system 500 as well as the rate of transfer of data from the units of the adaptation system 500 to external devices.

Alternatively, the adaptation system 500 does not comprise the memory unit 570 and the memory bus 575. The input data used by the adaptation system 500 is supplied by at least one external device, such as external memory or a processor, connected to the units of the adaptation system 500. Similarly, the output data produced by the adaptation system 500 is supplied to at least one external device, such as external memory or a processor, connected to the units of the adaptation system 500. The units of the adaptation system 500 are arranged to receive the data from each other via internal connections or via a data bus.

In a further embodiment of the adaptation system 500 according to the invention, the adaptation system 500 comprises a user interface 565 for communicating with the adaptation system 500. The user interface 565 comprises a display unit for displaying data to the user and a selection unit for making selections. Combining the adaptation system 500 with a user interface 565 allows the user to communicate with the adaptation system 500. The user interface 565 is arranged to display the geometric model. The user interface 565 is further arranged to display the contour illustrating a deformation of a geometric model resulting from its adaptation to the image data. The user interface 565 is further arranged to display tools for adapting the geometric model and configurations of the tools. The user interface 565 is further arranged to assist the selecting of the tools and of the configurations. Optionally, the user interface can comprise a plurality of modes of operation of the adaptation system 500 such as a manual mode and an automatic mode of operation. The skilled person will understand that more functions can be advantageously implemented in the user interface 565 of the adaptation system 500.

Alternatively, the adaptation system can employ an external input device and/or an external display connected to the adaptation system 500 via the input connectors 582 and/or 583 and the output connector 592. The skilled person will also understand that there exist many user interfaces that can be advantageously comprised in the adaptation system 500 of the current invention.

The adaptation system 500, such as the one shown in FIG. 5, of the invention may be implemented as a computer program product and can be stored on any suitable medium such as, for example, magnetic tape, magnetic disk, or optical disk. This computer program can be loaded into a computer arrangement comprising a processing unit and a memory. The computer program product, after being loaded, provides the processing unit with the capability to carry out the rendering, tasks.

FIG. 6 schematically shows an embodiment of the image acquisition system 600 employing the adaptation system 500 of the invention, said image acquisition system 600 comprising an image acquisition system unit 610 connected via an internal connection with the adaptation system 500, an input connector 601, and an output connector 602. This arrangement advantageously increases the capabilities of the image acquisition system 600 providing said image acquisition system 600 with advantageous segmentation capabilities of the adaptation system 500. Examples of image acquisition systems are, but not limited to, a CT system, an X-ray system, an MRI system, an Ultrasound system, a Positron Emission Tomography (PET) system, and a Single Photon Emission Computed Tomography (SPECT) system.

FIG. 7 schematically shows an embodiment of the workstation 700. The system comprises a system bus 701. A processor 710, a memory 720, a disk input/output (I/O) adapter 730, and a user interface (UI) 740 are operatively connected to the system bus 701. A disk storage device 731 is operatively coupled to the disk I/O adapter 730. A keyboard 741, a mouse 742, and a display 743 are operatively coupled to the UI 740. The adaptation system 500 of the invention, implemented as a computer program, is stored in the disk storage device 731. The workstation 700 is arranged to load the program and input data into memory 720 and execute the program on the processor 710. The user can input information to the workstation 700 using the keyboard 741 and/or the mouse 742. The workstation is arranged to output information to the display device 743 and/or to the disk 731. The skilled person will understand that there are numerous other embodiments of the workstation known in the art and that the present embodiment serves the purpose of illustrating the invention and must not be interpreted as limiting the invention to this particular embodiment.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word “comprising” does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the system claims enumerating several units, several of these units can be embodied by one and the same item of hardware or software. The usage of the words first, second and third, etcetera does not indicate any ordering. These words are to be interpreted as names.

1. An adaptation method (200) of adapting a geometric model to an image data, said adaptation method comprising:
a region selection step (230) for selecting a region of the geometric model; and
a manual adaptation step (235) for manually adapting the geometric model to the image data using a set of characteristics of the region comprised in the geometric model.

2. An adaptation method (200) as claimed in claim 1 wherein the geometric model comprises a tool for manually adapting the geometric model and the adaptation method (200) further comprises a tool selection step (225) for selecting the tool.

3. An adaptation method (200) as claimed in claim 1 wherein the geometric model comprises a configuration of the tool for manually adapting the geometric model and the adaptation method (200) further comprises a configuration selection step (230) for selecting the configuration.

4. An adaptation method (200) as claimed in claim 1 further comprising an automatic adaptation step (215) for automatically adapting the geometric model to the image data wherein the manual adaptation step further comprises a boundary condition step for manually setting a boundary condition for the automatic adaptation step.

5. An adaptation method (200) as claimed in claim 1 further comprising a segmenting step for segmenting the image data.

6. An adaptation system (200) for adapting a geometric model to an image data, said adaptation system comprising
a region selection unit for selecting a region of the geometric model; and
a manual adaptation unit for manually adapting the region to the image data on the basis of a region characteristic of the region comprised in the geometric model.

7. An image acquisition system (600) for acquiring an image data comprising an adaptation system (200) as claimed in claim 6.

8. A workstation (700) comprising an adaptation system (200) as claimed in claim 6.

9. A computer program product to be loaded by a computer arrangement, comprising instructions for adapting a geometric model to an image data, the computer arrangement comprising a processing unit and memory, the computer program product, after being loaded, providing said processing unit with the capability to carry out the following tasks:
selecting a region of the geometric model; and
manually adapting the region to the image data on the basis of a region characteristic of the region comprised in the geometric model.
